(19) United States
(12) Patent Application Publication
(10) Pub. No.: US 2005/0123236 A1
(43) Pub. Date: Jun. 9, 2005

(54) Optical module with multiplexer

(76) Inventors: Jeong-Hoon Ko, Daejon (KR); Jong-Ho Kim, Daejon (KR); Dae-Sok Oh, Daejon (KR)

Correspondence Address: DILWORTH & BARRESE, LLP, 333 EARLE OVINGTON BLVD., UNIONDALE, NY, 11553, US

(21) Appl. No.: 10/505,578

(22) PCT Filed: Feb. 25, 2003
(86) PCT No.: PCT/KR03/00367

(30) Foreign Application Priority Data
Feb. 25, 2002 (KR) 10-2002-0009964

(51) Int. Cl. G02B 6/28

(52) U.S. Cl. 385/24

(57) ABSTRACT

This invention discloses an optical module with multiplexer for a remote of an IMT-2000 digital optical repeater. The functions of an optical transmitting part of the digital optical repeater according to the present invention is data donation through a forward link, data add/drop in each sector, data summing in respective sectors and data transmission through a reverse link. This invention discloses an optical module with multiplexer that is capable of implementing the optical transmitting part's function effectively by using a signal framing, scrambling, add/drop and PLL circuits with high Q value.

### PRIORITY

This application claims priority to applications entitled “An Optical Module With Multiplexer” which were filed with the Korean Intellectual Property Office on Feb. 25, 2002 and filed as PCT application Ser. No. PCT/KR03/00367 on Feb. 25, 2003, the contents of each of which are hereby incorporated by reference.

### BACKGROUND

This invention relates to an optical module with multiplexer for remote equipment in an IMT-2000 digital optical repeater network.

To reduce the number of base stations in a mobile telecommunication network, an analog type repeater has been used until now. Nowadays digital type repeaters are beginning to be used, having the following merits, i.e. for IMT-2000 service, a number of repeaters can be connected in cascade, the total distance in the repeater network can be widely expanded, the add/drop control at every repeater can be done flexibly, the time delay in the various network can be compensated, and the monitoring and controlling of transmission environment can be processed by software.

In the digital type repeater, since digitalizing CDMA signals combining the signals from multiple subscribers allows a large volume of data to be transmitted, an effective optical transmission and time division multiplexing (TDM) is very important factor in an IMT-2000 network. However, the type of the digital optical repeater has not been standardized until now, and general methods for multiplexing have not been formed.

FIG. 1 shows a general network structure of an IMT-2000 digital optical repeater. In FIG. 1, the optical transmission is bi-directional over a single fiber. In IMT-2000 systems, three sectors are used and 4 FAs (frequency allocations) are allocated to each sector. As a donor and many remotes share their signal bandwidth, the donor distributes the same data to many remotes along with forward direction data. The remotes transmit the data along with reverse direction data and re-transmit them after summing the transmitted data to the signals received from a local antenna in respective sectors. Of three sectors, only one assigned sector signal is processed at each remote. The remote can have multiple sub-branches in addition to a main branch.

The general structure of an optical transmission part for the remote is shown in FIG. 2. The optical signals (FOR) transmitted over a forward link by the donor are delivered through a WDM (Wavelength Division Multiplexer) coupler (102) is transmitted into an optical receive-demultiplexing module (103). The optical receive-demultiplexing module (103) outputs forward linked payload data D (α, β, γ)_{FWD} by processing of optical receiving and demultiplexing.

The payload data means a source data to be transmitted through the optical path after digital processing and coding of the CDMA signals combining multiple subscribers' signals in a digital optical repeater α, β, γ represent the three respectively [respective?] sectors. The payload data are transformed to the signals FOT1, FOT2, which are replicas of FOR signals and transmitted over a main branch and a sub-branch through an optical transmission and multiplexing modules (105, 106) and WDM couplers (107, 108).

An optical switch (101) is applied to the main branch and executes a function for bypassing signals to the next remote after skipping over a troubled remote, for example when a power failure in a remote precludes signal transmission to the next remote. In this bypassing case, it is required that optical signals are transmitted over 2 span optical links. Therefore, as for the main branch, an optical link having a long distance transmitting ability compared to the sub-branch should be considered. For example, it is possible to realize this case by using an optical splitter and setting a power ratio through a grading method like 2:1, rather than 1:1.

In each remote, of the payload data D (α, β, γ)_{FWD} only payload data D₀ (−)_{FWD} of one selected sector for a local remote is dropped and a payload data D₀ (−)_{RVS} of one sector is added at the same time.

The adding means adds the local payload data with a payload data D₁ (α, β, γ)_{RVS} obtained from the main branch and a payload data D₂ (α, β, γ)_{RVS} obtained from the sub-branch through the optical receiving demultiplexing module (112, 113) and transmits them in the reverse direction through an optical transmit multiplexing module (109).

Since the optical fiber lengths of the main branch and the sub-branch are not fixed, the phase of the payload data D₀(−)_{RVS} corresponding to a local remote, the payload data D₁ (α, β, γ)_{RVS} from the main, and the payload data D₂(α, β, γ)_{RVS} from sub-branch are not the same. Therefore, these phases should be aligned before summing them. So, each payload data phase is aligned through a phase aligner (111) and the payload data becomes D₁ (α, β, γ)_{RVS}, D₂ (α, β, γ)_{RVS} and D₀ (−)_{RVS}, respectively.

The summed payload data in respective sectors D_{S}(α, β, γ)_{RVS} are transmitted in the reverse direction through an optical transmission multiplexing module (109) and a WDM coupler (102). But until now, an optical module with multiplexer to realize an optical transmission part having a data signal multiplexing function for a remote and an optical transmission/receiving function has not been disclosed.

A conventional system is described in Korean patent publication number 10-2001-18675, entitled “An Apparatus For Data Processing To The Reverse Direction Link In A Digital Optical Repeater And The Method Thereof”, whose applicant is SK Telecom Inc.

But the digital optical repeater according to the disclosed functions of such conventional systems for an A/D converting, D/A converting, optical transmission, multiplexing, demultiplexing and adding (or summing), which are well known to the skilled person in this field, fails to disclose a detailed structure.

Another system is described in Korean patent publication number 10-2001-755, entitled “A Digital Signal Splitting Telecommunicating System For CDMA”, whose applicant is Ino System Co., Ltd. This system discloses a step for digital signalization of CDMA analog signals and a WDM method using an optical path in an optical repeater, but does not disclose a module for optically transmitting the digitalized data.

Another system is described in Korean patent publication number 10-2001-48227, entitled “A Cascade Type Digital Optical Repeater”, whose applicant is Mobitech Co., Ltd. This system merely relates to a technology for handling RF signals that will be applied to an optical module, but does not disclose the optical module itself.

### SUMMARY OF THE INVENTION

An advantage of the present invention is to provide an optical module capable of realizing an optical transmitting part of a multiplexing and optical transmit/receive function for a remote.

The present invention preferably provides an optical module with multiplexer for optical transmission of remotes of an IMT-2000 digital optical repeater network having base stations, multiple remotes positioning downwards of said base stations, wherein said multiple remotes and are connected to a remote or a base station upwards and connected to a main branch or sub-branches downwards.

The present invention is characterized by an optical transmitting part of said optical repeater comprises a function for data distribution through forward link, a function for dropping/adding data per sector, a function for summing three data in respective sectors, and a function for data transmission through reverse link, and simply the high speed multiplexing data is connected to the 1:16 bit deinterleaved data and 16:1 bit interleaver before said high speed multiplexing data is demultiplexed into low speed payload in the format of data transmission in the forward link.

In the present invention it is preferable that said optical module with multiplexer further include a PLL circuit as a narrow band pass filter, and said PLL circuit filters the clock extracted from the high-speed multiplexing signals received from a forward link and said extracted clock is divided into 16 clocks and said divided clocks are supplied as a reference clock to all the clock generating and 16:1 bit interleavers and clock extraction and 1:16 bit deinterleavers of forward and reverse link.

The present invention provides an advantage of said optical module with multiplexer further providing a drop/add selecting function.

The present invention provides a further advantage of said optical multiplexing signals are divided and transmitted in order to transmit said high-speed multiplexing signals downward to the main branch and sub-branch in the forward link by using an optical splitter, and said optical splitter distributes more optical power to the main branch of the optical link to be possibly by-passed than the sub-branch.

The present invention provides a still further advantage of said optical module with multiplexer further providing a means for making the added data and dropped data delay in a corresponding repeater to the extent of a predetermined time for a smooth handover between remotes.

Other purposes and merits of the present invention will be clarified after reading the detail description of the invention and referring to the attached drawings.

### BRIEF DESCRIPTION OF DRAWINGS

FIG. 1 is a general network structure for an IMT-2000 digital optical repeater;

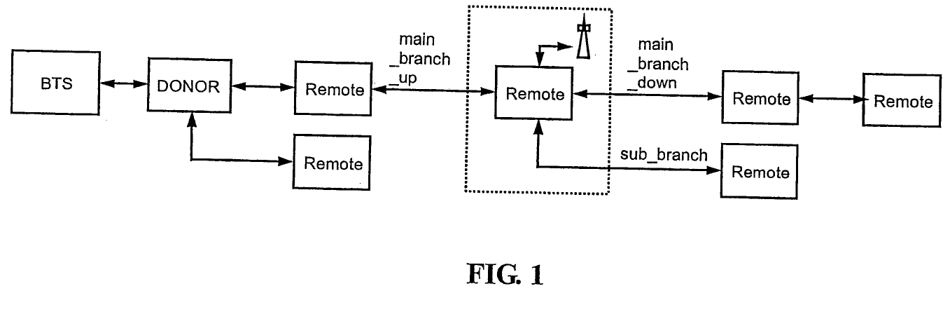

FIG. 2 is a general structure of an optical transmitting part for a remote;

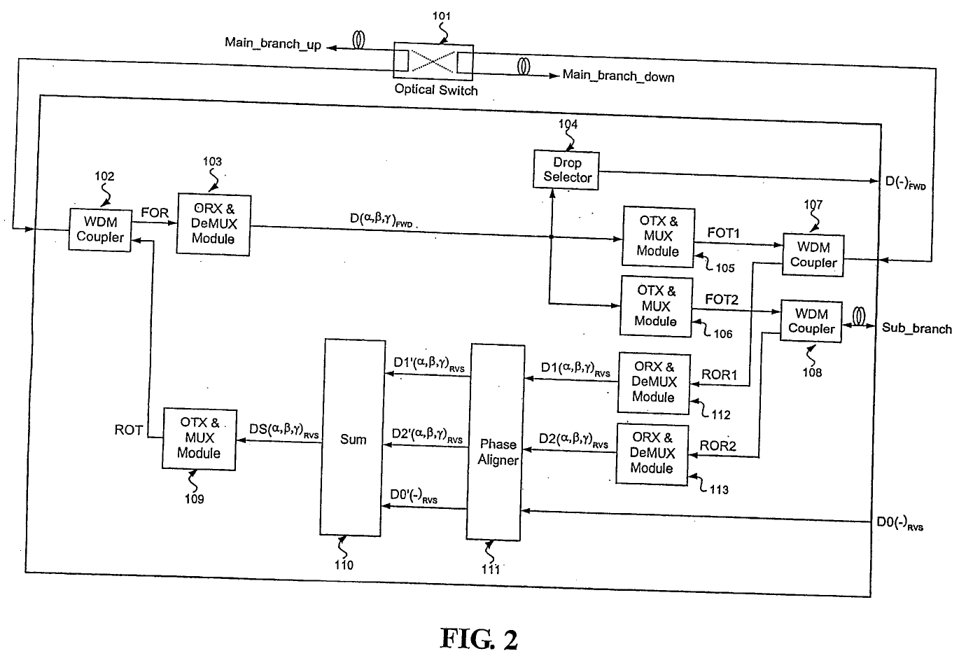

FIG. 3 is a structure of an optical module with multiplexer according to the present invention;

FIG. 4 is wave diagram for payload data, clock signals and synchronization signals used in the FIG. 3;

FIG. 5 is a structural view of the Mx/16 Hz PLL according to the present invention; and

FIG. 6 is a structural view of the elastic storing equipment according to the present invention.

### DETAILED DESCRIPTION OF THE PREFERRED EMBODIMENTS

Although a remote according to the present invention can process all the signals of three sectors, for simplicity of explanation the embodiment below describes processing of only one sector.

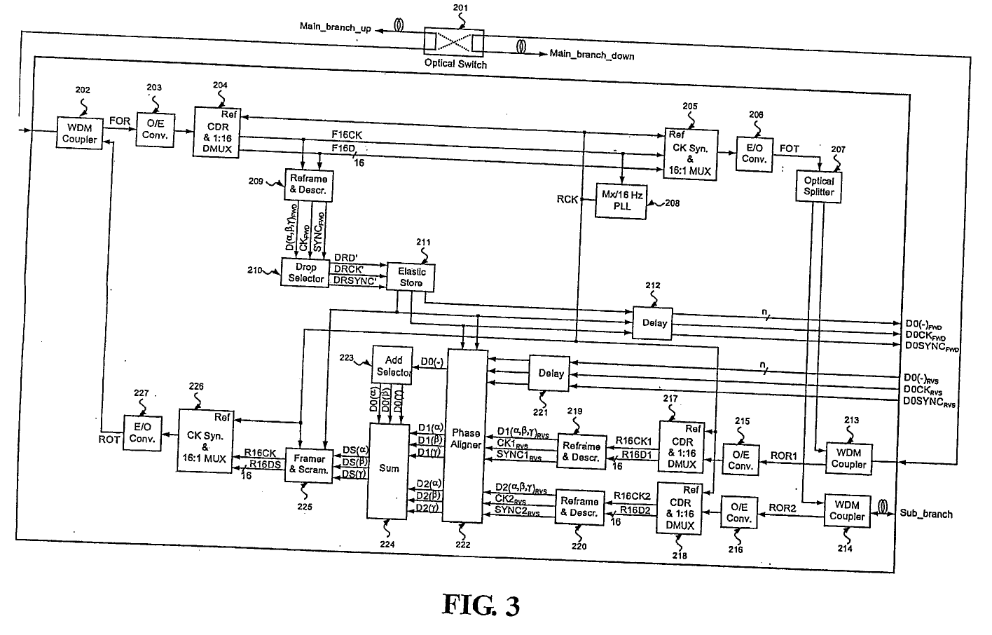

The structure of an optical module with multiplexer according to the present invention is shown in FIG. 3. In the present invention, the high-speed multiplexing signals with Mx bits per second (bps) transmitting speed is formed by multiplexed low speed payload data that are formed in n sequence of signals having Tr bps speed, and it includes overhead bits formed by a frame align signal for forming frame, a parity bit signal for monitoring the transmission performance and data communication channel (DCC) bits. The payload data D(α, β, γ) is accompanied with a clock signal CK that is synchronized to the payload data and a synchronization signal SYNC for indicating signal position in the payload data that is not included in the high-speed multiplexing signal data.

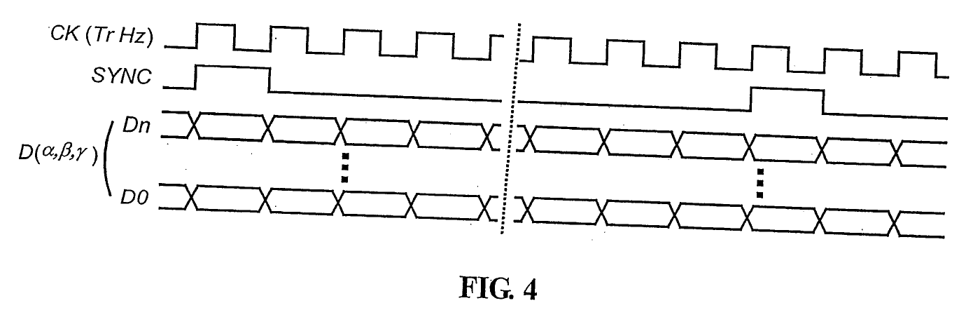

FIG. 4 shows a waveform of signals D (α, β, γ), CK, SYNC. That is, FIG. 4 illustrates a wave diagram of the payload data, the clock and the synchronization signal used in FIG. 3.

In order to multiplex the low speed payload data according to the present invention, 16 stages parallel framing with a processing speed of Mx/16 bps and parallel scrambling are executed, and then multiplexed to high-speed multiplexing signal by using 16:1 bit interleaver. And vice versa in the receiving part, payload data are separated to 16 sequences of data signal by using 1:16 bit deinterleaver and realizing of 16 stages of parallel reframing and parallel descrambling.

As the high-speed multiplexing signal received on the forward link should be transferred downwards to the main branch and sub-branch without change, the way to do this in the present invention is connecting 1:16 bit deinterleaved signals of Mx/16 bps instead of connecting in the form of payload data that is used generally. By doing so, the present invention can minimize the signal delay generated in the steps for de-multiplexing and multiplexing into the payload data and can obviate a circuit for multiplexing the payload data. An optical signal FOR received from a WDM coupler (202) is converted into 1:16 demultiplexed 16 parallel signals F16D and parallel output clock signals F16CK through an optical-to-electrical converter (203) and a clock extraction and 1:16 bit deinterleaver (204). In reverse processing, the F16D and F16CK become FOT signals identical to the FOR through a clock generating and 16:1 bit interleaver (205) and an electrical-to-optical converter (206).

Generally, optical signals to be transmitted downwards to main branch and sub-branch are made by an extra electrical-to-optical converter, and transmitted downwards through WDM couplers (226, 227) respectively after distributing optical power of FOT signal by an optical splitter (207) in the present invention to reduce the usage of the expensive electrical-to-optical converter. At this time, the optical splitter (207) is controlled to distribute more optical power to main branch having long transmitting distance in case of a bypassing by differently distributing to main branch and sub-branch like 2:1.

By providing a clock of Mx/16 Hz RCK cleaned by suppressing jitter of Mx/16 Hz F16CK by using a narrow band filter Mx/16 Hz PLL (208) as a reference clock for a clock generating and 16:1 bit interleaver (205), the jitter of Mx bps multiplexed signal through the clock generating and 16:1 bit interleaver (205) is made small. This improves transmission performance and maximizes the number of repeaters connected in cascade by minimizing jitter accumulated through repeaters. The RCK is also provided to the clock generating and 16:1 bit interleaver (226) in reverse direction as a reference clock, and then the jitter of Mx bps multiplexed signal is made to be small. Also, the RCK is provided to clock extraction and 1:16 bit deinterleaver (204, 217, 218) as a reference clock obviating an extra clock oscillator.

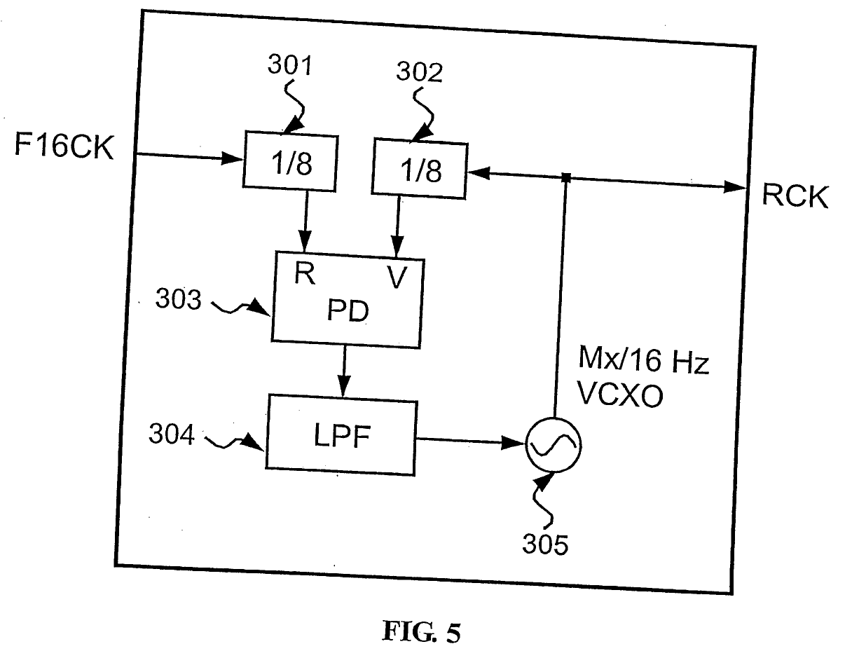

FIG. 5 illustrates a structure of Mx/16 Hz PLL (208). The signals F16CK and RCK are equally divided (here divided into 8 parts) and then inputted to a phase detector (303). The output of the phase detector (303) is applied to a low pass filter (304) designed to have low enough cutoff frequency and low enough jitter gain, and the low pass filter supplies a control voltage of Mx/16 Hz VCXO (305), and then finally a jitter suppressed RCK, which is synchronized to F16CK is obtained. For this jitter reducing PLL VCXO (voltage controlled crystal oscillator) is adequate to applied because it is insensitive to noise due to its small gain.

In FIG. 3, at the same time of transferring data in the forward link to the next remote without change, in order to select and drop payload of an assigned sector to a remote, the F16CK and F16D is inputted again to the reframe and de-scrambler (209), and the payload data D (α, β, γ)_{FWD} with its accompanied data CK_{FWD}, SYNC_{FWD} are extracted. Finally through the drop selector (210) the payload signal DRD′ of an assigned sector and its accompanied DRCK′ and DRSYNC′ are selected from D (α, β, γ)_{FWD} which contains all sector signals.

Since the dropped signal outputted from the drop selector is processed with gapped clock F16CK extracted from FOR signal received in forward link, the data has irregular period, i.e. the data has the information only at valid time slots.

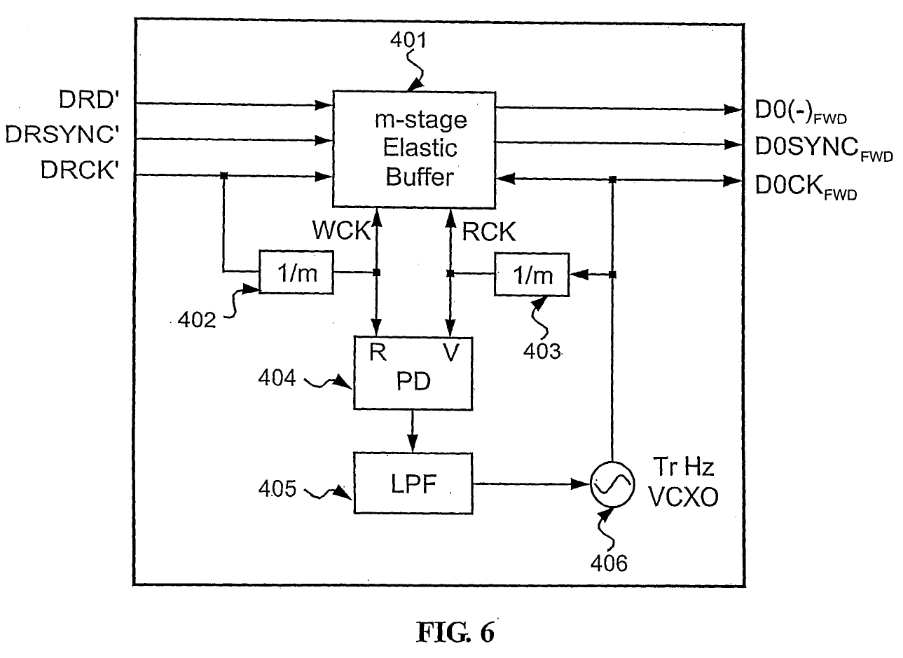

This data of irregular period becomes a DO(−)_{FWD} transformed to data with smoothed Tr bps period, its synchronized smoothed clock DOCK_{FWD} and synchronizing signal DOSYNC_{FWD} through the elastic store (211). FIG. 6 shows the structure of the elastic store (211) according to the present invention.

If the buffer in the elastic store (211) has m stages, inputted gapped clock DRCK′ and the output DOCK_{FWD} of Tr Hz VCXO (406) are equally divided and then inputted to a phase detector (404).

The output of the phase detector controls VCXO (406) in voltage through a low pass filter (405) designed to have low enough cutoff frequency and low enough jitter gain, and then jitter suppressed Tr Hz DOCK_{FWD} having smoothed period is generated.

By using the smoothed clock DOCK_{FWD}, smoothed data DO(−)_{FWD} and DOSYNC_{FWD} are read and then outputted. In an elastic buffer with m stages, each buffer is written by Tr/m Hz clock and then read with time interval. Due to the characteristics of the PLL removing the phase difference in FIG. 6, the phase relation between WCK and RCK may be maintained, and time difference between the writing clock and the reading clock by using this phase relation can be controlled to be maximized.

The multiplexed optical signals ROR1 and ROR2 received through the WDM coupler of (213, 214) of FIG. 3 are inputted into clock extraction and 1:16 bit deinterleaver (217, 218) through the optical-to-electrical converter (215, 216). In the clock extraction and 1:16 bit deinterleaver of (217, 218), parallel clocks of Mx/16 Hz, R16CK1 and R16CK2, 16 parallel data signals R16D1 and R16D2 are outputted. The parallel data with a parallel clock are reframed and descrambled at the reframe and de-scrambler of (219, 220) and are demultiplexed, and generate payload data D1(α, β, γ)_{RVS} and D2(α, β, γ)_{RVS} output respectively. The payload data D1 (α, β, γ)_{RVS} and D2 (α, β, γ)_{RVS} are accompanied by CK1_{RVS}, SYNC1_{RVS} and CK2_{RVS}, SYNC2_{RVS} respectively. The added data DO(−)_{RVS} and the drop data DO(−)_{FWD} at the remote are delayed in the delay (221, 222) respectively to the extent of predetermined time for a good handover between each remote.

The delay controlled add data to a predetermined time should be phase-aligned to 2 groups of payload data received from the main branch and the sub-branch to sum them in respective sectors. A phase aligner (222) aligns the 3 sectors' payload data based on a reference signal of DOCK_{FWD} and DOSYNC_{FWD} outputted from an elastic buffer (211). The payload data signal of the corresponding remote DO(−) passed through the phase aligner (220) is inputted only into a corresponding sector's port of 3 sectors of the summer (224). This is to choose DO(−) signal at an input port connected to the add selector (223) and summer (224) so that the chosen signal is effective only in one of DO(α), DO(β), DO(γ). The adder (224) outputs signals DS(α), DS(β), DS(γ) that are signals made by summing data in respective sectors. The summed data are multiplexed into 16 parallel signals of R16DS with R16CK of Mx/16 Hz clock forming a frame by the frame and scrambler (225) and are transformed to high-speed multiplexing signals by the clock synthesizing and 16:1 bit interleaver (226), and is transmitted over the reverse link through the electrical-to-optical converter (227).

Advantages of the present invention include minimizing the signal delay minimized by directly connecting the 16 data sequences obtained through 1:16 bit deinterleaving to 16:1 bit interleaver before demultiplexing the high-speed multiplexing signals to payload data in order to transfer signals received from the upper side to the next remote in the forward link. The optical repeater module according to the present invention can also obviate the frame and scrambler circuit for multiplexing payload data in relaying the data, and can minimize the jitter accumulation in network, after filtering parallel clocks with 16 divided parts by using PLL having high Q value and making clock with reduced jitter, by providing the clock with reduced jitter as a reference clock to the clock generating and 16:1 bit interleaver for the forward and reverse link.

The optical repeater module of the present invention can function for selecting a corresponding sector signal for a remote's dropping/adding and a function for summing data of 3 sectors in respective sectors, making it unnecessary to have an extra external circuits for these functions and signal interfacing circuits.

Also, in the optical repeater module of the present invention, the delay function of the added data for a handover is executed in the optical repeater module and so it is not necessary to have extra external circuits to do that.

Additionally, the optical repeater module of the present invention can minimize the use of the clock generator and the voltage control crystal oscillator by providing a clock from one Mx/16 Hz PLL as a reference clock simultaneously to all of 2 clock generator and 16:1 bit interleavers for high-speed multiplexing in the forward and reverse direction, and to all of 3 clock extractor and 1:16 bit deinterleavers for extracting clocks from high-speed multiplexing signal received in the forward and reverse direction.

It will be recognized that the invention can be modified and implemented in various forms that are not limited to the specific embodiments shown in the detailed description of this invention. The present invention is not confined to the embodiments described above, but rather includes all the modifications and replacements within the scope and sprit of the following claims.

1. An optical module with multiplexer for optical transmission for a remote of an IMT-2000 digital optical repeater network having base stations, multiple remotes positioned downwards of said base stations, wherein said multiple remotes are connected to a remote or a base station upward and connected to a main branch or sub-branch, comprising an optical transmitting part of said optical repeater that functions for data distribution through a forward link, for dropping/adding data per sector, for summing three data sectors in respective sectors, and for data transmission through a reverse link, wherein high speed multiplexing data is connected to 1:16 bit deinterleaved data and a 16:1 bit interleaver before said high speed multiplexing data is demultiplexed into low speed payload in a format of data transmission in the forward link.

2. The optical module with multiplexer as set forth in claim 1, further comprising a PLL circuit as a narrow band pass filter, and said PLL circuit filters a clock extracted from the high-speed multiplexing signals received from the forward link and said extracted clock is divided into 16 clocks
and said divided clocks are supplied as a reference clock to all clocks for generating 16:1 bit interleavers and clocks for extracting 1:16 bit deinterleavers of the forward and reverse links.

3. The optical module with multiplexer as set forth in claim 1, further comprising a drop/add selecting function.

4. The optical module with multiplexer as set forth in claim 3, wherein said optical multiplexing signals are divided and transmitted to transmit said high-speed multiplexing signals downwards to the main branch and sub-branch in the forward link by using an optical splitter, wherein said optical splitter distributes more optical power to the main branch of the optical link to be possibly by-passed than the sub-branch.

5. The optical module with multiplexer as set forth in claim 4, wherein said optical module with multiplexer further comprises a means for delaying added data and dropped data in a corresponding repeater to the extent of a predetermined time for a smooth handover between remotes.

6. An optical module with multiplexer for optical transmission of a remote of an IMT-2000 digital optical repeater network having base stations, multiple remotes positioned downward of said base stations, wherein said multiple remotes are connected to a remote or a base station upward and connected to a main branch or sub-branches downwards, and the high-speed multiplexing signal has a transmission speed of Mx bits per second (bps) and is a multiplexed signal of low-speed payload data consisting of n signal sequences having a transmission speed of Tr bps, and the high-speed multiplexing signal includes a frame align signal for forming a frame, a parity bit signal for monitoring transmission performance, an overhead consisting of data communication channel bits, and the payload data accompanies a clock signal CK synchronized to the payload data and a synchronization signal SYNC for marking signal position in the payload data that is not included in the high-speed multiplexing signal data, said optical module with multiplexer comprises:
a first WDM coupler for inputting high-speed multiplexing signal transmitted from the upward side of a donor;
a first optical to electrical converter for converting an optical signal FOR received by said first WDM;
a first clock extraction 1:16 bit deinterleaver for bit demultiplexing to 1:16 after extracting clocks from output signals of said first optical to electrical converter;
a first reframe and descrambler for extracting payload data with overhead bit by getting frame synchronization after inputting 16 parallel data received from said first clock extraction and 1:16 bit deinterleaver;
a drop selector for selecting only payload data corresponding to a specific sector by inputting payload data received from said first reframe and descrambler;
an elastic store for transforming data with irregular period inputted from the output signal of the drop selector to smoothed data;
a first delayer for delaying to the extent of a predetermined time by inputting dropped signal D₀(−)_{FWD} from said elastic store in order to compensate the transmitting time difference between repeaters;
a first clock generating 16:1 bit interleaver for multiplexing to serial data from 16 parallel data by using Mx Hz clocks synthesized for high-speed multiplexing with a reference of Mx/16 Hz clock from the output signal of said first clock extraction and 1:16 bit deinterleaver;
a first electrical to optical converter for converting output signals of said first clock generating 16:1 bit interleaver to optical signals;
an optical power splitter for splitting the output signals of said first electrical to optical converter to a second and a third WDM couplers;
a second optical to electrical converter for inputting optical multiplexing signals ROR1 from said second WDM coupler for inputting the output signals split by said optical power splitter and payload data received from the main branched path;
a third optical to electrical converter for inputting optical multiplexing signals ROR1 from said third WDM coupler for inputting the output signals split by said optical power splitter and payload data received from the sub-branched path;
a second clock extraction and 1:16 bit deinterleaver for extracting clocks from the output signals of said second optical to electrical converter and for bit demultiplexing to 1:16;
a third clock extraction and 1:16 bit deinterleaver for extracting clocks from the output signals of said third optical to electrical converter and for bit demultiplexing to 1:16;
a second reframe and descrambler for receiving Mx/16 Hz R16CK1 parallel clocks from said second clock extraction and 1:16 bit deinterleaver and 16 parallel data signals R16D1;
a third reframe and descrambler for receiving Mx/16 Hz R16CK2 parallel clocks from said third clock extraction and 1:16 bit deinterleaver and 16 parallel data signals R16D2;
a second delayer for delaying to the extent of a predetermined time by inputting added data D₀(−)_{RVS} at a corresponding repeater in order to compensate the transmitting time difference between repeaters;
a phase aligner for inputting the output signals of said elastic store, said second and said third reframe and descramble in order to align the phases each other and to add the time delayed adding data by through said second delayer to 2 groups of payload data received from the main and sub-branched paths;
an add selector for classifying the payload data made from remotes and inputted by said phase aligner to each sector in order to add to payload data received from the reverse link;
a summer for summing the payload data made by the remotes and the payload data received through a reverse link in respective sectors by inputting the output signals of said add selector and the output signals of said phase aligner;
a framer and scrambler for forming frame by inputting the outputs of said elastic store and said summer and multiplexing to Mx/16 Hz clock R16CK signals and 16 parallel signals R16DS;
a second clock generating and 16:1 bit interleaver for transforming to high-speed multiplexing signals by inputting the output signals of said framer and scrambler;
a narrow-band filter Mx/16 Hz PLL for providing a reference clock to said first and said second clock extraction and 1:16 bit deinterleaver, said first and said second clock generating and 1:16 bit deinterleaver and said framer and scrambler by jitter-suppressing Mx/16 Hz F16CK inputted from said first clock extraction and 1:16 bit deinterleaver and generating a clear clock RCK; and
a second electrical to optical transformer for transforming to said first WDM coupler through a reverse link by inputting the high-speed multiplexing signals from said second clock generating and 16:1 bit inverter.

7. The optical module with multiplexer as set forth in claim 6, wherein said elastic store comprises:
an m-stage elastic buffer for equally dividing an un-smoothed clock DRCK′ and D0CK_{FWD} output of Tr Hz VCXO into m clocks and outputting said divided clocks to a first phase detector (PD); and
a first low pass filter (LPF) for making jitter suppressed Tr Hz D0CK_{FWD} having a uniform period by inputting the output of said first phase detector and controlling the input voltage of said VCXO.

8. The optical module with multiplexer as set forth in claim 6, wherein said Mx/16 Hz PLL comprises:
two frequency dividers for equally dividing said F16CK and RCK respectively;
a second phase detector for inputting the output of said dividers;
a second low pass filter for inputting the output of said second phase detector; and
an Mx/16 Hz VCXO (Voltage Controlled Crystal Oscillator) for producing RCK signal jitter-suppressed and synchronized to F16CK from the output of said second low pass filter.
